(19) United States
(12) Patent Application Publication
(10) Pub. No.: US 2024/0394596 A1
(43) Pub. Date: Nov. 28, 2024

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Akihiro YAMAGUCHI, Kita Tokyo (JP); Ken UENO, Tachikawa Tokyo (JP); Ryusei SHINGAKI, Setagaya Tokyo (JP)

(73) Assignee: KABUSHIKI KAISHA TOSHIBA, Tokyo (JP)

(21) Appl. No.: 18/588,886

(22) Filed: Feb. 27, 2024

(30) Foreign Application Priority Data
May 23, 2023 (JP) 2023-084370

(51) Int. Cl. G06N 20/00

(52) U.S. Cl. CPC G06N 20/00

(57) ABSTRACT

According to one embodiment, an information processing device includes one or more processors. The one or more processors are configured to: detect whether input waveform data is in a first state by using a detection model; acquire a plurality of pieces of second state waveform data in a second state detected in advance by using the detection model when detected to be in the first state; learn a classification model for classifying whether waveform data is in the first state or the second state, by using first state waveform data detected to be in the first state and the plurality of pieces of second state waveform data as learning data, to generate one or more partial waveform patterns serving as a basis for indicating that the first state waveform data is in the first state; and output the generated partial waveform pattern.

### CROSS-REFERENCE TO RELATED APPLICATIONS

This application is based upon and claims the benefit of priority from Japanese Patent Application No. 2023-084370, filed on May 23, 2023; the entire contents of which are incorporated herein by reference.

### FIELD

Embodiments described herein relate generally to an information processing device, an information processing method, and a computer program product.

### BACKGROUND

In a class classification technique for time-series data (time-series waveform data) such as sensor data, it is desirable to clarify the basis of classification in addition to the classification performance. As a technique for clarifying the basis of classification, there is proposed a supervised shapelet learning method of learning together a shapelet that is a partial waveform pattern effective for classification in addition to a classification model (classifier).

Meanwhile, in abnormality detection of infrastructure facilities, manufacturing devices, and the like, it may be difficult to collect abnormal cases (abnormal data) during learning. For this reason, in addition to the improvement of the presentation performance of the determination basis and the abnormality detection performance, it is required to learn with only normal cases (normal data). Although this example is an example of performing classification into two abnormal and normal states (classes), there is a case where it is required to learn with only learning data of some states similarly for other examples of performing classification into a plurality of states.

### BRIEF DESCRIPTION OF THE DRAWINGS

FIG. 1 is a block diagram illustrating an information processing device according to a first embodiment;

FIG. 2 is a flowchart illustrating a learning process according to the first embodiment;

FIG. 3 is a flowchart illustrating an estimation process according to the first embodiment;

FIG. 4 is a flowchart illustrating a basis output process according to the first embodiment;

FIG. 5 is a block diagram illustrating an information processing device according to a second embodiment;

FIG. 6 is a flowchart illustrating a basis output process according to the second embodiment;

FIG. 7 is a diagram illustrating necessity of the second embodiment; and

FIG. 8 is a hardware configuration diagram illustrating the information processing device according to the embodiments.

### DETAILED DESCRIPTION

In general, according to one embodiment, an information processing device includes one or more processors. The one or more processors are configured to: detect whether input waveform data is in a first state by using a detection model; acquire a plurality of pieces of second state waveform data in a second state different from the first state, the second state waveform data being detected in advance by using the detection model when it is detected that the input waveform data is in the first state; and learn a classification model for classifying whether waveform data is in the first state or the second state, by using first state waveform data that is the input waveform data detected to be in the first state and the plurality of pieces of second state waveform data as learning data, to generate one or more partial waveform patterns serving as a basis for indicating that the first state waveform data is in the first state among a plurality of partial waveform patterns included in the first state waveform data.

Exemplary embodiments of an information processing device, an information processing method, and a computer program product will be explained below in detail with reference to the accompanying drawings. The present invention is not limited to the following embodiments.

Hereinafter, a case where a plurality of states (classes) to be classified are abnormal and normal is mainly described, but the state to be classified is not limited thereto and may be any state. In addition, an example in which time-series waveform data such as sensor data is input and a state of the input data is detected is described below, but the data to be processed is not limited to the time-series waveform data. Note that, hereinafter, the time-series waveform data may be simply referred to as waveform data.

As described above, a supervised shapelet learning method for learning a classification model and a shapelet together is proposed and attracts attention in the fields of data mining and machine learning. Such a technique has explanatory properties because a shapelet can be specified and presented to a user and has high presentation performance of a determination basis because class labels such as normal and abnormal can be utilized during learning. In addition, a technique is actively updated at present, and a technique that eliminates the need for hyperparameter adjustment and a technique that achieves high classification performance are proposed.

Note that, even when the same learning data is used, the shapelets serving as the determination bases may be different each time learning is performed. As a result, the presented shapelets are different every time despite the same abnormality, and a situation that confuses the user may occur. Therefore, for the same state (abnormality or the like), it is desirable to present the same shapelet as much as possible.

### First Embodiment

An information processing device according to a first embodiment is configured to satisfy the following requirements.
Learning is performed without abnormal data (only normal data).
The determination basis is presented.
Adjustment of a hyperparameter is not required.
Abnormality detection performances and determination basis presentation performances are high.

For example, the information processing device according to the embodiment uses a supervised shapelet learning method when a determination basis is presented with a detection model learned only from normal data. In order to implement this, the information processing device learns a shapelet not before an operation but during an operation in which an abnormality detection is performed. Since there is at least one piece of abnormal data at the time of abnormality detection, the information processing device can present a determination basis by the supervised shapelet learning method.

The time during the operation is a phase in which estimation (also referred to as detection, inspection, inference, and the like) using a detection model is performed. The time before the operation is a phase of preparing a detection model to be used for estimation, and for example, the detection model is learned. The time before the operation and the time during the operation may be referred to as a learning phase and an estimation (inference) phase, respectively.

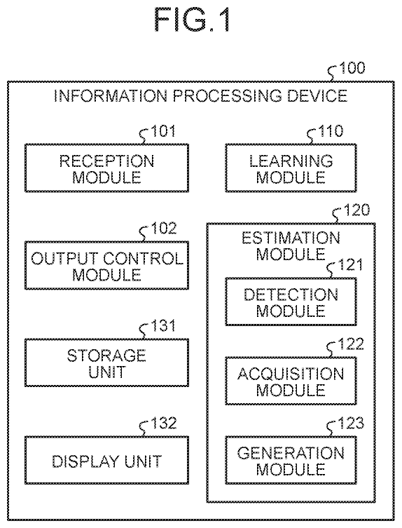

FIG. 1 is a block diagram illustrating an example of a configuration of an information processing device 100 according to the first embodiment. As illustrated in FIG. 1, the information processing device 100 includes a reception module 101, a learning module 110, an estimation module 120, an output control module 102, a storage unit 131, and a display unit 132.

The reception module 101 receives inputs of various types of information to be used in the information processing device 100. For example, the reception module 101 receives learning data used for learning by the learning module 110, time-series waveform data (input waveform data) to be estimated, and designation of various parameters used for learning or estimation.

The parameter is, for example, the following information.
Maximum number and minimum number of shapelets to be presented (output)
Upper limit of the number of repetitions of the processing of generating a shapelet to be presented
Number of pieces of normal waveform data (an example of second state waveform data) acquired to be compared with input waveform data in which an abnormality is detected (abnormal waveform data, example of first state waveform data)

The learning module 110 learns the detection model. In the present embodiment, the learning module 110 does not apply the supervised shapelet learning method. That is, the learning module 110 does not specify a shapelet during learning. The detection model may be learned by any method as long as the detection model is a model with which an abnormality and a normality of the waveform data can be detected.

The learning module 110 learns the detection model by using, for example, a plurality of pieces of normal time-series waveform data (normal time-series data set) collected in advance as learning data. For example, the learning module 110 generates an unsupervised waveform feature amount using the Minirocket and learns a detection model implemented by the following technique by using the generated waveform feature amount.
Support Vector Data Description (DeepSVDD)
Empirical-Cumulative-distribution-based Outlier Detection (ECOD)

If a combination of Minirocket and ECOD is used, it is not required to adjust hyperparameters for the detection model. The learning module 110 stores the detection model obtained by learning and the feature amount used during learning, for example, in the storage unit 131. The stored detection model and feature amount are used for estimation by the estimation module 120.

The estimation module 120 estimates the state of the time-series waveform data to be estimated by using the learned detection model. The estimation module 120 includes a detection module 121, an acquisition module 122, and a generation module 123.

The detection module 121 detects whether the input waveform data is abnormal (an example of the first state) by using the detection model.

When the abnormality is detected, the acquisition module 122 acquires a plurality of pieces of normal waveform data that are normal (an example of the second state). The normal waveform data is waveform data detected in advance as normal waveform data by using the detection model. For example, the acquisition module 122 acquires a plurality of pieces of normal waveform data from a normal waveform data set collected in advance.

The normal waveform data set is stored in advance in the storage unit 131, for example, as a data set including a plurality of pieces of waveform data estimated to be normal by the detection model. The acquisition module 122 acquires a plurality of pieces of normal waveform data from the normal waveform data set stored in the storage unit 131 by at least one of the following methods (M1) to (M4).

(M1) When the number of cases (the number of pieces of data) of the normal waveform data set is small, the acquisition module 122 acquires all the normal waveform data included in the normal waveform data set.

(M2) The acquisition module 122 acquires normal waveform data similar to the abnormal waveform data. Whether the pieces of data are similar to each other is determined, for example, based on whether the distance between the pieces of data is a threshold (distance threshold) or less. The distance is, for example, a Euclidean distance between the input waveform data and the normal waveform data, or a dynamic time warping (DTW) distance.

(M3) In a case where a detection model is used to generate a feature amount at the time of abnormality detection, the acquisition module 122 acquires normal waveform data in which a feature amount used in detection by the detection model is similar to a feature amount of abnormal waveform data.

(M4) In a case where a detection model including a plurality of partial detection models according to a difference in a state of the device, a season, and the like is used, the acquisition module 122 acquires normal waveform data (normal waveform data related to the partial detection model that contributes to abnormality detection) used for detection by the partial detection model that detects an abnormality among the plurality of partial detection models.

An example of the above (M4) is described. For example, it is assumed that the detection model includes a plurality of partial detection models according to the season. In a case where such a detection model is used, the estimation module 120 estimates the input waveform data, for example, by using a partial detection model corresponding to a season at a time when an abnormality is detected. When it is detected that the input waveform data is normal, the corresponding input waveform data is added to the normal waveform data set of the storage unit 131 as the normal waveform data. At this time, the normal waveform data is stored in association with, for example, a season at the time when detection is performed or information indicating the partial detection model used for detection. The acquisition module 122 can specify the normal waveform data detected to be normal by the same partial detection model as the partial detection model used to detect the abnormality by referring to this information.

When the reception module 101 receives the designation of the number of pieces of normal waveform data to be acquired, the acquisition module 122 may acquire the designated number of pieces of second state waveform data.

When abnormality of the input waveform data is detected by the detection module 121, the generation module 123 generates one or more shapelets by using the input waveform data and the plurality of pieces of normal waveform data acquired by the acquisition module 122. For example, the generation module 123 learns a classification model by using abnormal waveform data (first state waveform data) and a plurality of pieces of acquired normal waveform data as the learning data, thereby generating a shapelet.

The classification model is a model different from the detection model and is a model that classifies whether the input waveform data is abnormal or normal. The generated one or more shapelets correspond to a partial waveform pattern that becomes a basis indicating that the input waveform data is abnormal among a plurality of partial waveform patterns included in the input waveform data.

The process of generating the shapelet by the generation module 123 can be implemented by a procedure similar to that in the supervised shapelet learning method in the related art. Details of the processing by the generation module 123 is described below.

The output control module 102 controls output of various types of information used in the information processing device 100. For example, the output control module 102 outputs (displays) information indicating one or more shapelets generated by the generation module 123 to (on) the display unit 132.

At least a part of each unit (the reception module 101, the learning module 110, the estimation module 120, and the output control module 102) may be implemented by one processing unit. Each of the above units is implemented by, for example, one or a plurality of processors. For example, each of the above units may be implemented by causing a processor such as a central processing unit (CPU) and a graphics processing unit (GPU) to execute a program, that is, by software. Each of the above units may be implemented by a processor such as a dedicated integrated circuit (IC), that is, hardware. Each of the above units may be implemented by using software and hardware in combination. When a plurality of processors are used, each processor may implement one of the units or may implement two or more of the units.

The storage unit 131 stores various types of information to be used in the information processing device. For example, the storage unit 131 stores a normal waveform data set, information indicating a learned detection model, and the like.

Note that, the storage unit 131 can be configured by any generally used storage medium such as a flash memory, a memory card, a random access memory (RAM), a hard disk drive (HDD), and an optical disc.

The display unit 132 is an example of a device that displays various types of information used in the information processing device 100. The display unit 132 is implemented, for example, by a display device such as a liquid crystal display.

Note that the information processing device 100 may be physically configured by one device or may be physically configured by a plurality of devices. For example, the information processing device 100 may be constructed on a cloud environment. Furthermore, each unit in the information processing device 100 may be dispersedly provided in a plurality of devices. For example, the information processing device 100 (information processing system) may be configured to include a device (for example, a learning device) including a function required for learning (such as the learning module 110) and a device (for example, the estimation device) including a function required for estimation (such as the estimation module 120).

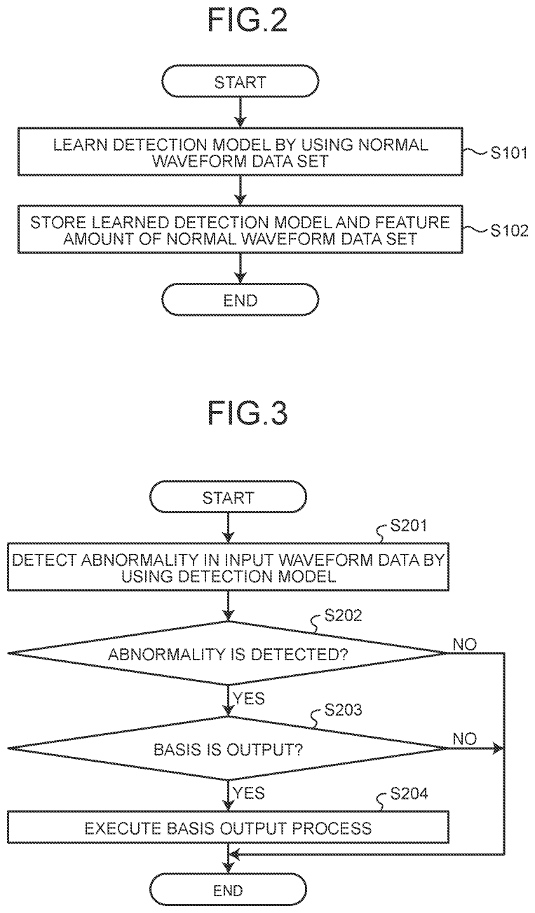

Next, the learning process by the information processing device 100 according to the first embodiment is described. The learning process is a process of learning the detection model before an operation. FIG. 2 is a flowchart illustrating an example of the learning process according to the first embodiment.

The learning module 110 learns the detection model by using a normal waveform data set collected in advance as learning data for learning the detection model (step S101). The learning module 110 stores the information indicating the learned detection model and the feature amount calculated during learning with respect to the normal waveform data set in the storage unit 131 (step S102) and ends the learning process.

Next, the estimation process by the information processing device 100 according to the first embodiment is described. The estimation process is a process of estimating a state of waveform data (input waveform data) input as an estimation target by using the learned detection model. FIG. 3 is a flowchart illustrating an example of the estimation process according to the first embodiment.

The detection module 121 detects an abnormality in the input waveform data by using the learned detection model (step S201). The estimation module 120 determines whether an abnormality is detected (step S202). When no abnormality is detected (step S202: No), the estimation process ends. Note that the output control module 102 may output information indicating that an abnormality is not detected.

If an abnormality is detected (step S202: Yes), the estimation module 120 determines whether to output a basis for the abnormality (step S203). For example, as a simple determination method, the estimation module 120 determines to output the basis every time an abnormality is detected. As another determination method, a method of accumulating abnormal waveform data for a certain period of time, determining to output the basis for the abnormality of one or more pieces of accumulated input waveform data when the certain period of time elapses, can be applied. As a result, for example, in a case where an abnormality is detected continuously for a short period of time, the basis can be collectively output.

When the basis is not output (step S203: No), the estimation process ends. When the basis is output (step S203: Yes), the estimation module 120 executes the basis output process (step S204). After the basis output process, the estimation process ends.

As described above, in the basis output process, a shapelet serving as a basis is generated and output using the supervised shapelet learning method. As described above, while the supervised shapelet learning method is executed in the related art before the operation (learning phase), in the present embodiment, a shapelet is learned using the supervised shapelet learning method and output as a basis during the operation (estimation phase).

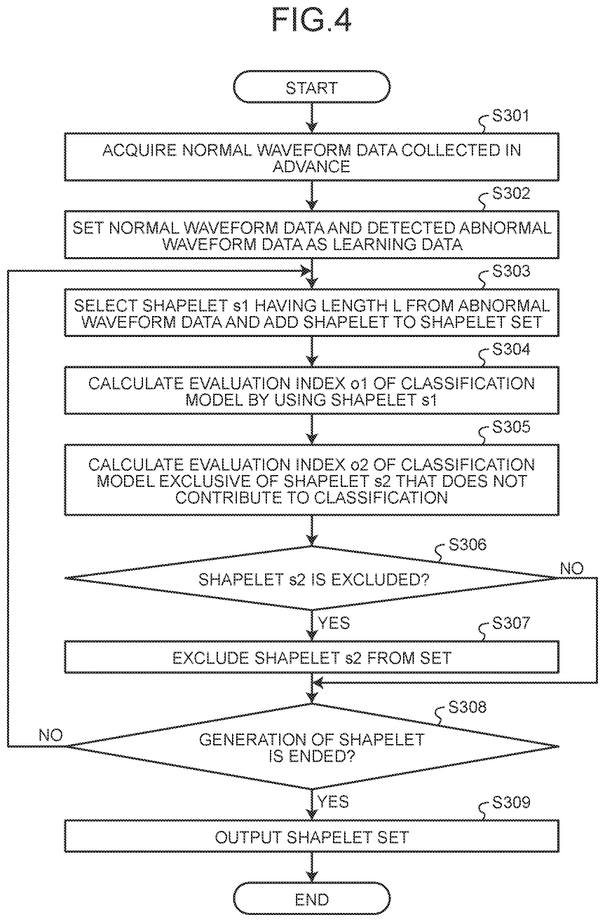

FIG. 4 is a flowchart illustrating an example of the basis output process in step S204.

For example, the acquisition module 122 acquires the plurality of pieces of normal waveform data from the normal waveform data set collected in advance (step S301). For example, the acquisition module 122 acquires a plurality of pieces of normal waveform data similar to the current abnormal waveform data from the normal waveform data set.

The generation module 123 sets, as the learning data, the plurality of pieces of acquired normal waveform data and abnormal waveform data that is input waveform data in which an abnormality is detected (step S302). When the basis is output every time an abnormality is detected, the number of pieces of abnormal waveform data is one. When the basis of the abnormality is output every certain period, the number of pieces of abnormal waveform data may be one or more. Steps S303 to S308 are repetition processes.

The generation module 123 selects a length L of the shapelet, selects a partial waveform having the length L from the abnormal waveform data and adds the partial waveform as a shapelet s1 to the shapelet set (step S303).

The shapelet set is a set for storing candidates of the shapelet to be output as basis. At the end of the basis output process, the shapelet stored in the shapelet set is output as a shapelet indicating the basis of the abnormality.

In step S303, the shapelet s1 is selected from the abnormal waveform data. As a result, a shapelet specific to abnormal waveform data can be acquired. As a simple method, the generation module 123 first randomly selects the length L of the shapelet and further randomly selects a partial waveform (segment) having the length L from the abnormal waveform data to obtain the shapelet s1.

In a case where two or more pieces of abnormal waveform data are included in the learning data, the generation module 123 randomly selects one piece of abnormal waveform data, for example, from two or more pieces of abnormal waveform data, and selects the shapelet s1 from the selected abnormal waveform data.

The generation module 123 calculates an evaluation index o1 of the classification model by using the shapelet s1 (step S304). For example, the generation module 123 calculates the feature amount of the learning data by using each of the shapelets included in the shapelet set to which the shapelet s1 is added and calculates the evaluation index o1 indicating the classification performance when the calculated feature amount is input to the classification model.

The feature amount can be calculated, for example, with a distance, similarity, or dissimilarity between the shapelet and each of the plurality of pieces of waveform data included in the learning data. As the distance, for example, a Euclidean distance at a place where the shapelet and the waveform data are the most similar can be used.

The classification model is a model that inputs a plurality of feature amounts calculated for each of the shapelets included in the shapelet set and outputs whether each waveform data is abnormal or normal. Since the learning data includes abnormal waveform data and normal waveform data, the learning data corresponds to teacher data in which a correct answer as to whether the data is abnormal or normal is obtained. The classification model is learned so as to reduce the class classification loss for such teacher data. The class classification loss can be interpreted as a value of an error function or a loss function.

As the classification model, for example, a logistic regression model can be used. In this case, a cross entropy loss can be used as the class classification loss.

The generation module 123 can use the following indexes as the evaluation index o1.
Any of Akaike information criterion (AIC), Bayesian information criterion (BIC), and Minimum Description Length (MDL) based on the class classification loss and complexity of a classification model.
Class classification loss in learning data.
Class classification loss in verification data. For example, in a case where there is a plurality of pieces of abnormal waveform data, the verification data is selected from a part of the learning data set in step S302. The remaining learning data is used in the learning in step S303 and subsequent steps.

The generation module 123 may determine a selection parameter to be used for selection of the shapelet s1 based on selection information obtained at the time of detection by the detection model and select the shapelet s1 according to the determined selection parameter.

The selection parameter is, for example, at least one of the length L of a shapelet to be selected and a range in which the shapelet is selected. The selection information is, for example, at least one of the length of the waveform data (waveform data contributing to abnormality detection) used when it is detected that the input waveform data is abnormal and the range including the partial waveform pattern in which it is detected that the waveform data is abnormal among the partial waveform patterns included in the input waveform data.

An example of a detection model that outputs such selection information is described. For example, the detection model may be an ensemble model in which a plurality of partial detection models having different lengths of waveform data used for abnormality detection are integrated. For example, the ensemble model detects an abnormality by each of the plurality of partial detection models, integrates a plurality of detection results, and outputs a final result indicating the presence or absence of the abnormality. At this time, the ensemble model outputs, as the selection information, information indicating the length of the waveform data used by the partial detection model contributing to the detection of the abnormality or the partial detection model contributing to the detection of the abnormality.

In a case where the detection model is a model that outputs the selection information, the generation module 123 can select the selection parameter according to the selection information output from the detection model and use the selection parameter for selection of the shapelet s1. That is, the detection model and the classification model are used independently in the related art, but in the present embodiment, the learning method of the classification model can be configured to be changed in consideration of the output by the detection model. Thus, for example, the presentation performance of the determination basis can be further improved.

Next, the generation module 123 calculates an evaluation index o2 of the classification model by using the shapelets included in the shapelet set in a case where a shapelet s2 that does not contribute to the class classification is assumed to be excluded from the current shapelet set (step S305). The evaluation index o2 can be calculated by the same method as the evaluation index o1.

For example, in a case where a linear classification model such as logistic regression is used, the generation module 123 selects a shapelet corresponding to a feature amount having the minimum absolute value of the classification weight as the shapelet s2 that does not contribute to class classification. The generation module 123 calculates the evaluation index o2 by using the shapelets other than the selected shapelet s2 included in the shapelet set.

The generation module 123 determines whether to exclude the shapelet s2 (step S306). As a simple method, the generation module 123 compares the evaluation index o1 with the evaluation index o2 and determines to exclude the shapelet s2 if the evaluation index o2 (corresponding to an evaluation index in a case where the shapelet s2 is assumed to be excluded from the shapelet set) is a value indicating better evaluation. In a case where the maximum number of shapelets is designated as a parameter, the generation module 123 may determine to exclude the shapelet s2 in a case where the number of shapelets included in the shapelet set exceeds the maximum number.

Note that, in the first round of the repetition process (steps S303 to S308), only one shapelet s1 is included in the shapelet set. Therefore, the process of excluding the shapelet s2 from the shapelet set may be skipped. Even in a case where skipping is not performed, in a case where it is assumed that the shapelet s1 is excluded, since the shapelet is not included in the shapelet set, the value of the evaluation index o2 is not a value indicating a better evaluation than the evaluation index o1, and it is determined that the shapelet is not excluded.

In a case where it is determined to exclude the shapelet s2 (Step S306: Yes), the generation module 123 excludes the shapelet s2 from the shapelet set (Step S307). In a case where the shapelet s2 is excluded, the generation module 123 updates the value of the evaluation index o1 to the value of the evaluation index o2.

After excluding the shapelet s2 or in a case where it is not determined to exclude the shapelet s2 (Step S306: No), the generation module 123 determines whether to end the generation of the shapelet (Step S308). For example, in a case where the number of times of the repetition process (steps S303 to S308) reaches the upper limit, the generation module 123 determines to end the generation of the shapelets.

In a case where it is determined not to end the generation of the shapelet (step S308: No), the process returns to step S303, the next shapelet is added, and the process is repeated.

In a case where it is determined to end the generation of the shapelet (step S308: Yes), the output control module 102 outputs the shapelet included in the shapelet set as the shapelet as a basis for abnormality detection (step S309).

By such a process, the generation module 123 can calculate the feature amount of the learning data by using the selected shapelet, calculate an evaluation index when the calculated feature amount is input to the classification model, and generate one or more shapelets of which the evaluation index is larger than other shapelets as shapelets to be bases for abnormality detection.

As described above, the information processing device according to the first embodiment can detect an abnormality by using a detection model learned only from normal data and learn and output a shapelet serving as a basis for abnormality detection, when an abnormality is detected (during the operation). As a result, even in a case where the model is learned with only learning data of some states, classification using the corresponding model can be executed with higher accuracy. Furthermore, in the present embodiment, the information processing device can be configured to use a model that does not require adjustment of hyperparameters.

### Second Embodiment

In a case where abnormality detection and basis presentation are repeated for a plurality of pieces of input waveform data, an information processing device according to a second embodiment outputs (presents) a shapelet having a small difference in determination performance and similar to the previously presented shapelet.

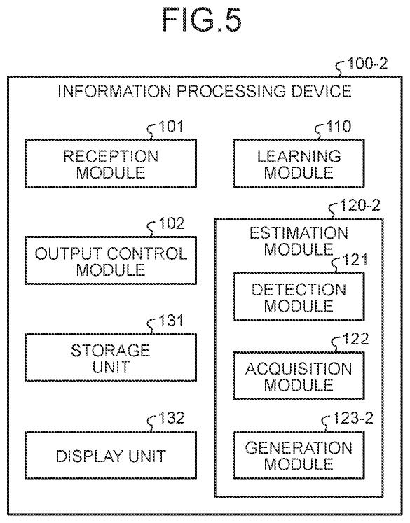

FIG. 5 is a block diagram illustrating an example of a configuration of an information processing device 100-2 according to the second embodiment. As illustrated in FIG. 5, the information processing device 100-2 includes the reception module 101, the learning module 110, an estimation module 120-2, the output control module 102, the storage unit 131, and the display unit 132.

In the second embodiment, a function of a generation module 123-2 in the estimation module 120-2 is different from that of the first embodiment. Other configurations and functions are similar to those in FIG. 1 that is the block diagram of the information processing device 100 according to the first embodiment and thus are denoted by the same reference numerals, and description thereof here is omitted.

The following function at the time of generating a shapelet for a plurality of pieces of input waveform data input as an estimation target is added to the generation module 123-2. It is assumed that the generation module 123-2 generates a shapelet sA (first partial waveform pattern) for input waveform data DA (first input waveform data). As a shapelet sB (second partial waveform pattern) with respect to input waveform data DB (second input waveform data) input thereafter, the generation module 123-2 generates a shapelet excluding a shapelet that is not similar to the shapelet sA and has a difference in classification performance (evaluation index) with respect to the classification model learned with the shapelet sA, the difference not being a threshold or more.

In the present embodiment, the detection module 121 detects whether the input waveform data is abnormal by using the detection model for each of the plurality of pieces of input waveform data. Furthermore, the reception module 101 may be configured to receive designation of a threshold (an example of a parameter) to be compared with the difference in classification performance by the generation module 123-2.

Note that the learning process of the present embodiment is similar to that of FIG. 2 of the first embodiment, and thus description thereof is omitted. Note that the overall flow of the estimation process of the present embodiment is similar to that in FIG. 3 illustrating the estimation process of the first embodiment. In the present embodiment, details of the basis output process (step S204) included in the estimation process are different from those of the first embodiment.

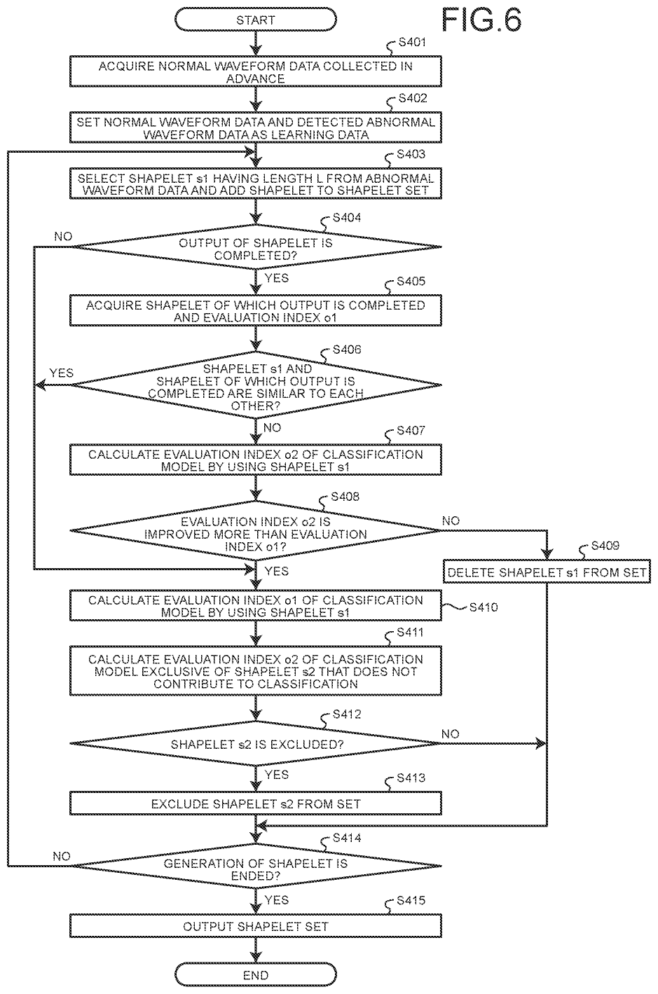

Hereinafter, the basis output process of the present embodiment is described with reference to FIG. 6. FIG. 6 is a flowchart illustrating an example of the basis output process according to the second embodiment. Note that FIG. 6 is executed every time one piece of input waveform data is input.

Since steps S401 to S403 are similar to steps S301 to S303 of the basis output process of the first embodiment, the description thereof is omitted.

In the present embodiment, the generation module 123-2 determines whether output of a shapelet is completed (step S404). For example, in a case where the process is executed on the input waveform data input for the second and subsequent times among the plurality pieces of input waveform data, and the output process (step S415 described below) of the shapelet is performed on the input waveform data input before the corresponding input waveform data, the generation module 123-2 determines that the output of the shapelet is completed.

In a case where the output of the shapelet is not completed (step S404: No), the process similar to that of the first embodiment is executed. That is, the generation module 123-2 executes steps S410 to S415 corresponding to steps S304 to S309 of the first embodiment. Since steps S410 to S415 are the processes similar to steps S304 to S309 of the first embodiment, the description thereof is omitted.

In a case where the output of the shapelet is completed (step S404: Yes), the generation module 123-2 acquires the shapelet set of which the output is completed and the evaluation index o1 calculated for the corresponding shapelet set (step S405). The generation module 123-2 determines whether the shapelets included in the acquired shapelet set are similar to the shapelet s1 selected this time (step S406).

For example, the generation module 123-2 calculates a Euclidean distance between each of one or more shapelets included in the shapelet set and the shapelet s1. In a case where there is a Euclidean distance that is the threshold or less among the calculated one or more Euclidean distances, the generation module 123-2 determines that the shapelet included in the shapelet set is similar to the shapelet s1.

In a case where it is determined that the shapelets are similar to each other (Step S406: Yes), the generation module 123-2 executes steps S410 to S415 that are processes similar to steps S304 to S309 of the first embodiment.

When it is determined that the shapelets are not similar to each other (step S406: No), the generation module 123-2 calculates the evaluation index o2 of the classification model by using the added shapelet s1 (Step S407). For example, the generation module 123 calculates the feature amount of the learning data by using the shapelet s1 and calculates the evaluation index o2 indicating the classification performance when the calculated feature amount is input to the classification model.

The generation module 123-2 compares the evaluation index o2 with the evaluation index o1 calculated for the shapelet set of which the output is completed, and determines whether the evaluation index o2 calculated by using the current shapelet s1 is improved (step S408). For example, the generation module 123-2 calculates a difference between the evaluation index o1 calculated for the shapelet set of which the output is completed (corresponding to the shapelet sA) and the evaluation index o2 calculated by using the shapelet s1 and determines that the evaluation index o2 is improved when the difference is a threshold or more.

In a case where the evaluation index o2 is improved (Step S408: Yes), the generation module 123-2 executes steps S410 to S415 that are processes similar to steps S304 to S309 of the first embodiment.

In a case where the evaluation index o2 is not improved (Step S408: No), the generation module 123-2 deletes the shapelet s1 from the shapelet set (step S409) and determines whether to end the generation of the shapelet (step S414).

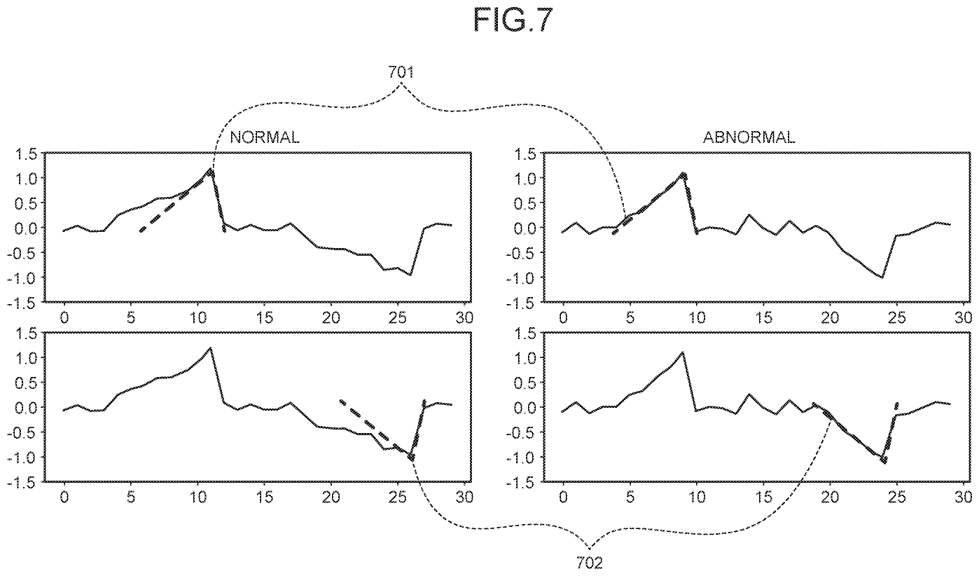

FIG. 7 is a diagram illustrating necessity of the present embodiment. The waveform data illustrated in the two graphs on the left side of FIG. 7 is an example of normal waveform data. The waveform data illustrated in the two graphs on the left side of FIG. 7 is an example of abnormal waveform data. The example illustrated in FIG. 7 is an example in which whether the normal waveform data and the abnormal waveform data are abnormal by two shapelets 701 (upwardly sharp shapelet) and 702 (downwardly sharp shapelet) can be determined. That is, the normality and the abnormality are correctly classified regardless of whether any one of the shapelets 701 and 702 is used.

In a case where the process as in the present embodiment is not performed, different shapelets are likely to be output as a basis of abnormality detection each time determination is made regardless of whether input waveform data having a similar shape is input.

In the present embodiment, in order to avoid the occurrence of such a situation, if the current abnormality can also be detected by a shapelet similar to the shapelet presented as the determination basis in the past, a shapelet having a shape similar to the shapelet presented in the past is presented as the current determination basis. In the example of FIG. 7, for example, in a case where the shapelet 701 has been output in the past, the shapelet 701 is also output as the determination basis for the current input waveform data.

As described above, in the second embodiment, a shapelet having a small difference in determination performance and being similar to the previously presented shapelet can be output. As a result, for example, it is possible to avoid occurrence of a situation in which the presented shapelets are different every time despite the same abnormality and output the same shapelets as much as possible for the same abnormality.

As described above, according to the first to second embodiments, even when a model is learned with only learning data of some states, classification using the corresponding model can be executed with higher accuracy.

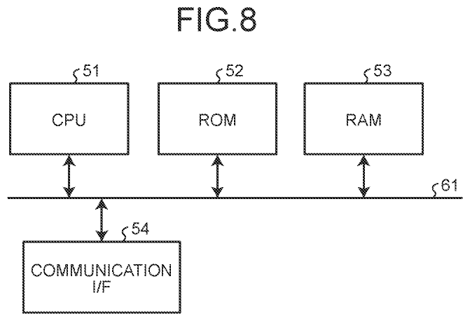

Next, a hardware configuration of the information processing device according to the first or second embodiment is described with reference to FIG. 8. FIG. 8 is an explanatory diagram illustrating a hardware configuration example of the information processing device according to the first or second embodiment.

The information processing device according to the first or second embodiment includes a control device such as a CPU 51, storage devices such as a read only memory (ROM) 52 and a RAM 53, a communication I/F 54 that is connected to a network and performs communication, and a bus 61 that connects the respective units.

The program executed by the information processing device according to the first or second embodiment is provided by being incorporated in the ROM 52 or the like in advance.

The program executed by the information processing device according to the first or second embodiment may be configured to be provided as a computer program product by being recorded as a file in an installable format or an executable format in a computer-readable recording medium such as a compact disk read only memory (CD-ROM), a flexible disk (FD), a compact disk recordable (CD-R), or a digital versatile disk (DVD).

Furthermore, the program executed by the information processing device according to the first or second embodiment may be configured to be stored on a computer connected to a network such as the Internet and provided by being downloaded via the network. In addition, the program executed by the information processing device according to the first or second embodiment may be configured to be provided or distributed via a network such as the Internet.

The program executed by the information processing device according to the first or second embodiment can cause the computer to function as each unit of the information processing device described above. In this computer, the CPU 51 can read the program from a computer-readable storage medium onto a main storage device and execute the program.

Configuration examples of the embodiment are described below.

(Configuration example 1) An information processing device includes a memory and one or more processors coupled to the memory. The one or more processors are configured to: detect whether input waveform data is in a first state by using a detection model; acquire a plurality of pieces of second state waveform data in a second state different from the first state, the second state waveform data being detected in advance by using the detection model when it is detected that the input waveform data is in the first state; and learn a classification model for classifying whether waveform data is in the first state or the second state, by using first state waveform data that is the input waveform data detected to be in the first state and the plurality of pieces of second state waveform data as learning data, to generate one or more partial waveform patterns serving as a basis for indicating that the first state waveform data is in the first state among a plurality of partial waveform patterns included in the first state waveform data.

(Configuration example 2) In the device according to Configuration example 1, the one or more processors are configured to calculate a feature amount of the learning data by using the partial waveform pattern, calculate an evaluation index indicating classification performance when the calculated feature amount is input to the classification model, and generate the one or more partial waveform patterns in which the evaluation index is larger than other partial waveform patterns among the plurality of partial waveform patterns.

(Configuration example 3) In the device according to Configuration example 2, the one or more processors are configured to: determine a selection parameter that is at least one of a length of the partial waveform pattern to be selected and a range in which the partial waveform pattern is selected, based on selection information obtained at time of detection by the detection model; and select the partial waveform pattern from the first state waveform data according to the determined selection parameter and calculate the feature amount by using the selected partial waveform pattern.

(Configuration example 4) In the device according to Configuration example 3, the selection information is at least one of a length of the waveform data used when it is detected that the input waveform data is in the first state and a range including a partial waveform pattern detected to be in the first state among the partial waveform patterns included in the input waveform data.

(Configuration example 5) In the device according to any one of Configuration examples 2 to 4, the evaluation index includes: a class classification loss when the learning data is classified by the classification model; one of a Akaike information criterion, a Bayesian information criterion, and a minimum description length based on the class classification loss and complexity of the classification model; or a class classification loss when verification data is classified by the classification model.

(Configuration example 6) In the device according to any one of Configuration examples 2 to 5, the feature amount includes a distance between the partial waveform pattern and the learning data, a similarity between the partial waveform pattern and the learning data, or a dissimilarity between the partial waveform pattern and the learning data.

(Configuration example 7) In the device according to any one of Configuration examples 2 to 6, the one or more processors are configured to: detect whether the input waveform data is in the first state for each of a plurality of pieces of the input waveform data; and generate a first partial waveform pattern for first input waveform data included in the plurality of pieces of input waveform data and then generate, as the partial waveform pattern for second input waveform data included in the plurality of pieces of the input waveform data, a second partial waveform pattern excluding the partial waveform pattern that is not similar to the first partial waveform pattern and in which a difference in the classification performance with respect to the classification model learned by using the first partial waveform pattern is not a threshold or more.

(Configuration example 8) In the device according to Configuration example 7, the one or more processors are configured to: receive designation of the threshold; and generate the second partial waveform pattern by using the designated threshold.

(Configuration example 9) In the device according to any one of Configuration examples 1 to 8, the one or more processors are configured to acquire, among the plurality of pieces of second state waveform data, at least one of the second state waveform data similar to the input waveform data detected to be in the first state, and the second state waveform data in which a feature amount used in detection by the detection model is similar to a feature amount used in detection by the detection model with respect to the input waveform data detected to be in the first state.

(Configuration example 10) In the device according to any one of Configuration examples 1 to 9, the detection model includes a plurality of partial detection models, and the one or more processors are configured to acquire the second state waveform data used for detection by a partial detection model, which detects that the input waveform data is in the first state, among the plurality of partial detection models.

(Configuration example 11) In the device according to any one of Configuration examples 1 to 10, the one or more processors are configured to: receive designation of a number of the plurality of pieces of second state waveform data to be acquired; and acquire the number of pieces of second state waveform data.

(Configuration example 12) In the device according to any one of Configuration examples 1 to 11, the one or more processors are configured to output the generated partial waveform pattern.

(Configuration example 13) In the device according to any one of Configuration examples 1 to 12, the one or more processors includes: a processor configured to detect whether the input waveform data is in the first state; a processor configured to acquire the plurality of pieces of second state waveform data; and a processor configured to generate the one or more partial waveform patterns.

(Configuration example 14) An information processing method, executed by an information processing device, includes: detecting whether input waveform data is in a first state by using a detection model; acquiring a plurality of pieces of second state waveform data in a second state different from the first state, the second state waveform data being detected in advance by using the detection model when it is detected that the input waveform data is in the first state; learning a classification model for classifying whether waveform data is in the first state or the second state, by using first state waveform data that is the input waveform data detected to be in the first state and the plurality of pieces of second state waveform data as learning data, to generate one or more partial waveform patterns serving as a basis for indicating that the first state waveform data is in the first state among a plurality of partial waveform patterns included in the first state waveform data; and outputting the generated one or more partial waveform patterns.

(Configuration example 15) A computer program product includes a computer-readable medium including programmed instructions causing a computer to execute: detecting whether input waveform data is in a first state by using a detection model; acquiring a plurality of pieces of second state waveform data in a second state different from the first state, the second state waveform data being detected in advance by using the detection model when it is detected that the input waveform data is in the first state; learning a classification model for classifying whether waveform data is in the first state or the second state, by using first state waveform data that is the input waveform data detected to be in the first state and the plurality of pieces of second state waveform data as learning data, to generate one or more partial waveform patterns serving as a basis for indicating that the first state waveform data is in the first state among a plurality of partial waveform patterns included in the first state waveform data; and outputting the generated one or more partial waveform patterns.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising
one or more processors configured to:
detect whether input waveform data is in a first state by using a detection model;
acquire a plurality of pieces of second state waveform data in a second state different from the first state, the second state waveform data being detected in advance by using the detection model when it is detected that the input waveform data is in the first state; and
learn a classification model for classifying whether waveform data is in the first state or the second state, by using first state waveform data that is the input waveform data detected to be in the first state and the plurality of pieces of second state waveform data as learning data, to generate one or more partial waveform patterns serving as a basis for indicating that the first state waveform data is in the first state among a plurality of partial waveform patterns included in the first state waveform data.

2. The device according to claim 1, wherein
the one or more processors are configured to calculate a feature amount of the learning data by using the partial waveform pattern, calculate an evaluation index indicating classification performance when the calculated feature amount is input to the classification model, and generate the one or more partial waveform patterns in which the evaluation index is larger than other partial waveform patterns among the plurality of partial waveform patterns.

3. The device according to claim 2, wherein
the one or more processors are configured to:
determine a selection parameter that is at least one of a length of the partial waveform pattern to be selected and a range in which the partial waveform pattern is selected, based on selection information obtained at time of detection by the detection model; and
select the partial waveform pattern from the first state waveform data according to the determined selection parameter and calculate the feature amount by using the selected partial waveform pattern.

4. The device according to claim 3, wherein
the selection information is at least one of a length of the waveform data used when it is detected that the input waveform data is in the first state and a range including a partial waveform pattern detected to be in the first state among the partial waveform patterns included in the input waveform data.

5. The device according to claim 2, wherein
the evaluation index includes:
a class classification loss when the learning data is classified by the classification model;
one of a Akaike information criterion, a Bayesian information criterion, and a minimum description length based on the class classification loss and complexity of the classification model; or
a class classification loss when verification data is classified by the classification model.

6. The device according to claim 2, wherein
the feature amount includes a distance between the partial waveform pattern and the learning data, a similarity between the partial waveform pattern and the learning data, or a dissimilarity between the partial waveform pattern and the learning data.

7. The device according to claim 2, wherein
the one or more processors are configured to:
detect whether the input waveform data is in the first state for each of a plurality of pieces of the input waveform data; and
generate a first partial waveform pattern for first input waveform data included in the plurality of pieces of input waveform data and then generate, as the partial waveform pattern for second input waveform data included in the plurality of pieces of the input waveform data, a second partial waveform pattern excluding the partial waveform pattern that is not similar to the first partial waveform pattern and in which a difference in the classification performance with respect to the classification model learned by using the first partial waveform pattern is not a threshold or more.

8. The device according to claim 7, wherein
the one or more processors are configured to:
receive designation of the threshold; and
generate the second partial waveform pattern by using the designated threshold.

9. The device according to claim 1, wherein
the one or more processors are configured to acquire, among the plurality of pieces of second state waveform data, at least one of the second state waveform data similar to the input waveform data detected to be in the first state, and the second state waveform data in which a feature amount used in detection by the detection model is similar to a feature amount used in detection by the detection model with respect to the input waveform data detected to be in the first state.

10. The device according to claim 1, wherein
the detection model includes a plurality of partial detection models, and
the one or more processors are configured to acquire the second state waveform data used for detection by a partial detection model, which detects that the input waveform data is in the first state, among the plurality of partial detection models.

11. The device according to claim 1, wherein
the one or more processors are configured to:
receive designation of a number of the plurality of pieces of second state waveform data to be acquired; and
acquire the number of pieces of second state waveform data.

12. The device according to claim 1, wherein
the one or more processors are configured to output the generated partial waveform pattern.

13. The device according to claim 1, wherein
the one or more processors includes:
a processor configured to detect whether the input waveform data is in the first state;
a processor configured to acquire the plurality of pieces of second state waveform data; and
a processor configured to generate the one or more partial waveform patterns.

14. An information processing method executed by an information processing device, the method comprising:
detecting whether input waveform data is in a first state by using a detection model;
acquiring a plurality of pieces of second state waveform data in a second state different from the first state, the second state waveform data being detected in advance by using the detection model when it is detected that the input waveform data is in the first state;
learning a classification model for classifying whether waveform data is in the first state or the second state, by using first state waveform data that is the input waveform data detected to be in the first state and the plurality of pieces of second state waveform data as learning data, to generate one or more partial waveform patterns serving as a basis for indicating that the first state waveform data is in the first state among a plurality of partial waveform patterns included in the first state waveform data; and
outputting the generated one or more partial waveform patterns.

15. A computer program product comprising a non-transitory computer-readable medium including programmed instructions, the instructions causing a computer to execute:
detecting whether input waveform data is in a first state by using a detection model;
acquiring a plurality of pieces of second state waveform data in a second state different from the first state, the second state waveform data being detected in advance by using the detection model when it is detected that the input waveform data is in the first state;
learning a classification model for classifying whether waveform data is in the first state or the second state, by using first state waveform data that is the input waveform data detected to be in the first state and the plurality of pieces of second state waveform data as learning data, to generate one or more partial waveform patterns serving as a basis for indicating that the first state waveform data is in the first state among a plurality of partial waveform patterns included in the first state waveform data; and
outputting the generated one or more partial waveform patterns.
